(19) United States
(12) Patent Application Publication
(10) Pub. No.: US 2017/0371833 A1
(43) Pub. Date: Dec. 28, 2017

(54) CALCULATOR

(71) Applicant: Malik BOULANAACHE, Renens (CH)

(72) Inventor: Malik BOULANAACHE, Renens (CH)

(21) Appl. No.: 15/536,061

(22) PCT Filed: Dec. 15, 2014
(86) PCT No.: PCT/IB2014/002791

§ 371 Date: Jun. 14, 2017

(51) Int. Cl. G06F 15/02; G06F 3/02; G06F 3/0338

(52) U.S. Cl. CPC G06F 15/0216; G06F 15/0225; G06F 3/0219; G06F 3/0338

(57) ABSTRACT

A calculator's input interface includes a knob projecting above the top face of the casing. The knob is provided to allow numbers to be input manually. It is arranged to be able to be switched selectively into a plurality of active positions by tilting it in corresponding directions from an idle position. Each direction corresponds to a different digit to be entered in the calculator. The top face of the casing also has a plurality of first keys associated respectively with mathematical operators, the first keys being positioned relative to the knob in such a way that the ends of the fingers of a user's hand can each be located facing one of the first keys when the palm of the hand is turned downwards and the hollow of the hand covers the end of the knob.

### FIELD OF THE INVENTION

The present invention relates to an electronic calculator comprising a power supply, an input interface for entering numbers and mathematical operations to be carried out, a memory (for storing data, numbers and mathematical operations to be carried out), a microprocessor for carrying out operations on the entered numbers, a digital display device for showing the result of operations carried out on the entered numbers and a casing comprising a front (or proximal) edge and a rear (or distal) edge located opposite each other, the casing further comprising a base and an upper face both extending between the rear edge and the front edge. The invention equally relates to a stand-alone electronic calculator and to an electronic calculator acting as a computer peripheral device, the electronic calculator then being adapted to act as an input interface for a computer with which it communicates (wired or wireless). The present invention further relates to a method for using said electronic calculator.

### PRIOR ART

Numerous models of electronic calculators are known that correspond to the aforementioned definition. By way of an example, the calculator disclosed in patent document U.S. Pat. No. 4,217,656 can be cited. In known electronic calculators, the input interface is conventionally formed by a digital keypad. This digital keypad firstly comprises 10 keys corresponding to the numbers 0 to 9. In addition, it necessarily has to contain a certain number of command keys. Among the common command keys, four keys correspond to the four arithmetical operators: plus (+), minus (−), multiplication (×) and division (/) and one key corresponds to the calculation of the result (equals: =). Finally, the “decimal point” key (.) is provided to allow the decimals of fractional numbers to be entered.

One disadvantage of most pocket calculators and other known electronic calculators is that they are not adapted to one-handed non-visual entry. Indeed, the digital keypad of electronic calculators frequently comprises at least five rows of four keys. Such a high number of keys necessarily involves the fingers moving to-and-fro between the keys. Such to-and-fro movement virtually excludes a non-visual keystroke.

To attempt to overcome this problem, key “5” of the digital keypad is commonly provided with a small bump. This bump fulfils a similar function to that of the two bumps formed on the “F” and “J” keys of typewriters. Therefore, by virtue of the presence of the bump, by practicing to systematically return his middle finger so that it is above the “5” key after every keystroke, in principle a pocket calculator user can learn to keep his hand in a well-defined position relative to the digital keypad. However, experience shows that this technique is difficult to master and that it also causes considerable fatigue in the hand and the wrist.

### BRIEF DISCLOSURE OF THE INVENTION

An object of the present invention is to overcome the aforementioned problems of the prior art by providing an electronic calculator for which one-handed non-visual entry is facilitated. The present invention achieves this object by providing an electronic calculator according to appended claim 1.

According to the invention, numbers are entered using a lever of the “joystick” type. An advantage of this feature is that it is thus possible to control number entry using the hollow of the hand, with the fingers and the thumb therefore remaining free to simultaneously accomplish other tasks.

### BRIEF DESCRIPTION OF THE DRAWINGS

Further features and advantages of the present invention will become apparent upon reading the following description, which is provided solely by way of a non-limiting example, and with reference to the appended drawings, in which:

FIG. 1 is a slanted perspective top view showing a calculator corresponding to a first embodiment of the invention;

FIG. 2 is a schematic side view of the calculator of FIG. 1;

FIG. 3 is a slanted perspective bottom view of the calculator of FIGS. 1 and 2;

FIG. 4 is a view similar to FIG. 1 showing an electronic calculator corresponding to a second embodiment of the invention;

FIG. 5 is a schematic side view of the calculator of FIG. 4;

FIG. 6 is a view similar to that of FIGS. 1 and 4, showing an electronic calculator corresponding to a third embodiment of the invention;

FIG. 7 is a schematic side view of the calculator of FIG. 6;

FIG. 8 is a view similar to that of FIGS. 1, 4 and 6 showing an electronic calculator corresponding to a fourth embodiment mainly intended for left-handed users.

### DETAILED DESCRIPTION OF EMBODIMENTS

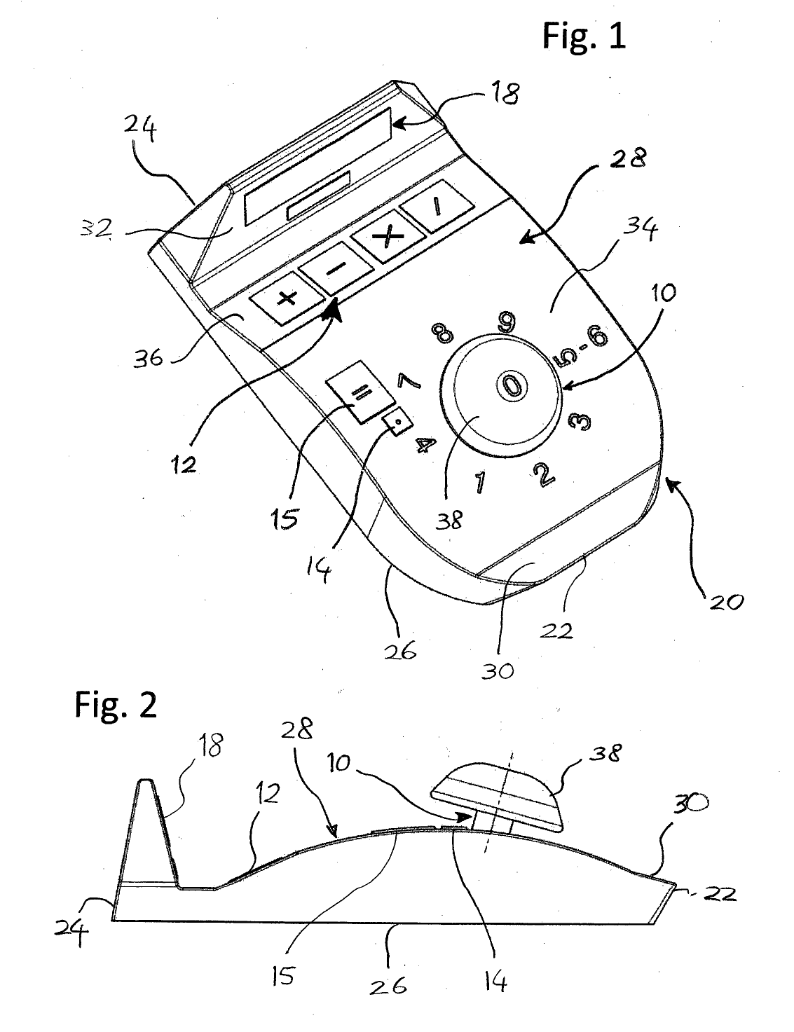

FIGS. 1, 2 and 3 show an electronic calculator that corresponds to a first specific embodiment of the invention. The calculator shown comprises a lever 10, four first keys that can be activated by the four fingers of the hand and are generally referenced using reference numeral 12, two second keys that can be activated by the thumb and are referenced using reference numerals 14 and 15, a display that is generally referenced using reference numeral 18 and a casing 20 that supports the lever, the keys and the display. In order to better understand the following explanations, the casing has been subdivided into a plurality of parts, which are a front (or proximal) edge 22, a rear (or distal) edge 24 located opposite the front edge, a lower face acting as a base 26 and an upper face 28. It will be understood that the base and the upper face each extend between the rear edge 24 and the front edge 22.

The upper face 28 of the casing in turn is further subdivided into a plurality of zones in the drawings. These zones are firstly a first zone 30 that directly adjoins the front edge 22 of the casing and a display zone 32 that is located at the very back in the vicinity of the rear edge 24. Two input zones 34 and 36 are interposed between the zones 30 and 32. The two input zones are the front input zone 34, which surrounds the lever 10, and the rear input zone 36, which contains the first keys 12 that can be activated by the four fingers of the hand. The first zone 30 does not have any keys, it optionally can act as a support zone for the hand of the user. Furthermore, in the embodiment of this example, the two second keys 14 and 15 are designed to be activated by the thumb. As shown in FIG. 1, the keys 14 and 15 are arranged behind the lever 10 in the input zone 34. It also will be noted that they are offset to the left-hand side relative to the longitudinal axis of the electronic calculator.

As can be seen in FIG. 1, the calculator keys bear distinctive signs. In this example, the four first keys respectively bear the signs that correspond to the four arithmetical operators. The order of the operators is as follows: from left to right, firstly the plus “+” sign, then the minus “−” sign, then the multiplication “X” sign and finally the division “/” sign. It also can be seen that one of the second keys 15 bears the equals “=” sign and that the other second key 14 bears a decimal point (as is common practice on calculators, the decimal point is favoured over a comma for separating the whole number part from the decimal number part of the numbers). In the example shown, the end of the lever 10 supports a cap 38, the top of which is marked with the number “0”. The signs that correspond to the other nine numbers are arranged in a circle around the lever 10 on the upper face 28.

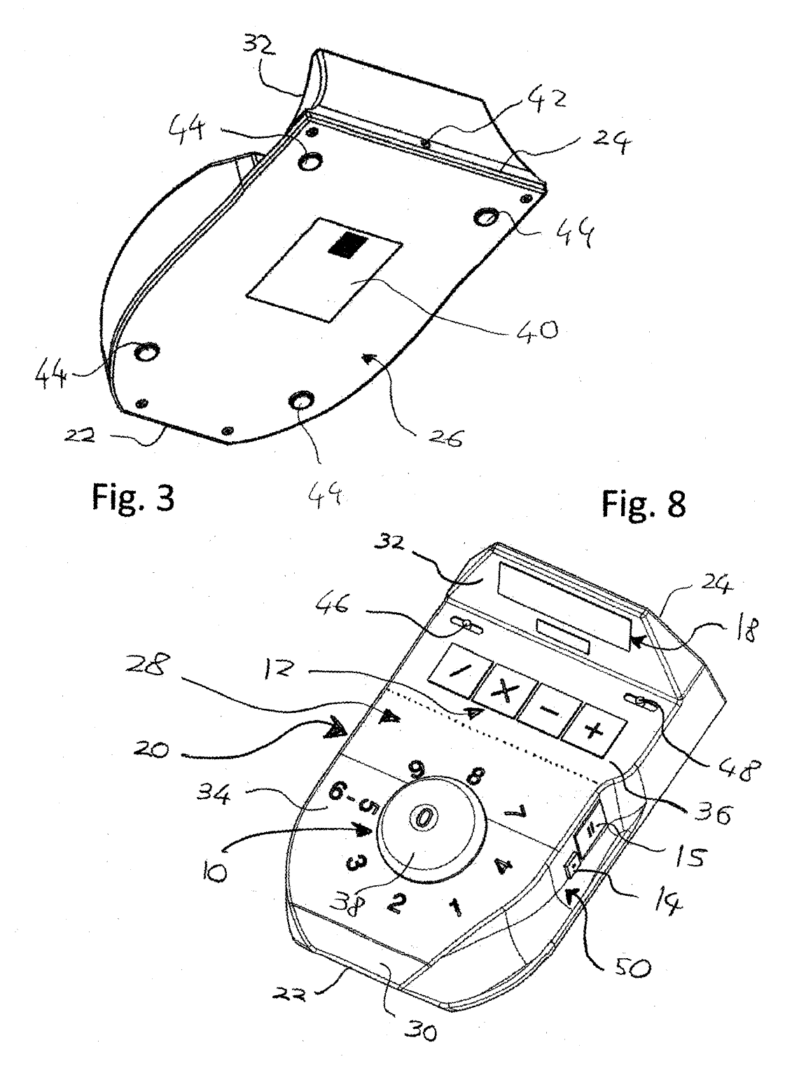

In the example shown, the display 18 is a digital display that can be of any type that is known to a person skilled in the art. For example, the display 18 can operate using light-emitting diodes (LED). Alternatively, it can comprise liquid-crystal cells (LCD), for example. The display and the various other electronic components of the calculator must be supplied with electricity. To this end, the calculator comprises a power supply (not shown). In the embodiment that is the object of FIGS. 1, 2 and 3, the power supply can be formed by three 1.5 V batteries, for example. The perspective view of FIG. 3 shows the cover 40 for a battery compartment, in which three batteries (not shown) are accommodated.

Still with reference to FIG. 3, a socket 42 is shown that is designed to receive the plug of the low voltage power cord (not shown) of a charger (not shown) connected to the supply network. The charger is designed to supply the calculator with direct current. According to various variants, this current can be used to recharge the batteries (if rechargeable batteries are used) or alternatively to power the calculator directly instead of batteries. Finally, FIG. 3 also shows four rubber feet 44 that are mounted under the base 26 of the calculator.

In a manner that is known to a person skilled in the art, the calculator according to the invention is further equipped with a microprocessor (not shown) and a memory (not shown). The keys 12, 14 and 15 are conventionally mounted in openings of the casing 20, so that they act as a contactor for controlling the microprocessor. The arrangement of the electronic components of the calculator and their operation will not be described in detail, since the invention does not directly relate to these issues. However, it is to be noted that a description of the operation of an electronic calculator can be found in the aforementioned patent document U.S. Pat. No. 4,217,656, for example, which is entitled “electronic calculator”. The document U.S. Pat. No. 4,217,656 is incorporated by reference in this description.

According to the invention, numbers are entered using the lever 10 instead of the digital keypad used in the calculators of the prior art. The lever 10 is of the “joystick” type. Such levers are known to a person skilled in the art. A description of such a joystick is found in patent document U.S. Pat. No. 4,124,787 entitled “joystick controller mechanism operating one or plural switches sequentially or simultaneously”, for example. This prior document is incorporated by reference in this description. Levers of the “joystick” type are also commercially available. In particular, model “COM-09032” can be cited, which is available from the sparkfun.com website. For the sake of simplification, the “input interface” of the calculator will hereafter refer to the assembly formed by the keys 12, 14 and 15 and the lever 10.

According to the invention, the lever 10 is mounted in an opening of the front input zone 34 and it is arranged so that it can be selectively tilted in a plurality of active positions by being inclined in various directions from its neutral position. As will be seen in further detail, each direction corresponds to a different number and the microprocessor is arranged to associate each tilt of the lever in one of the active positions with the entry of the corresponding number. According to the invention, the lever 10 is designed to be activated using the hollow of the hand. In order to use the input interface of the calculator according to the method for using the invention, the right hand is placed in the input position above the calculator. In the input position, the hand is turned with the palm downwards and the fingers are oriented parallel to the longitudinal axis of the calculator towards the rear edge 24. The hand is positioned relative to the calculator so that the palm covers the lever 10, the cap 38 of the lever 10 then can be inserted into the hollow of the hand in order to be guided between the edges thereof. It is to be noted that “hollow of the hand” refers to the small cavity that forms in the palm of the hand when it is slightly folded, with this cavity being bounded on one side by the base of the thumb.

According to the invention, the first keys 12 are positioned relative to the lever 10 so that the ends of the fingers of a hand of a user each can be located facing one of the first keys when this hand is in the input position. FIG. 1 shows that, in this example, the rear input zone 36 is inclined rearwards. Furthermore, the four first keys 12 are arranged so as to form a straight row that is oriented perpendicular to the longitudinal axis of the calculator. However, it will be understood that instead of forming a straight row, the first keys 12 can form a row in an arc of a circle, for example. Indeed, as has been seen, the first keys are designed to be each activated by a finger of the hand. Therefore, as the fingers of a hand are not all the same length, it can be advantageous for the keys to be arranged on an arc of a circle. In any event, it will be seen hereafter that, for ergonomic reasons, the row formed by the keys 12 is preferably oriented at a tangent to a circle concentric to the lever, whether the row is straight or in an arc of a circle.

Conventionally, the lever 10 is provided with switches forming a device designed to identify, following each tilt of the lever, the active position in which it is located. The microprocessor of the calculator receives a specific signal from this device for each active position of the lever. It will be understood that the microprocessor associates the signal supplied in a given active position with a specific number taken from the numbers zero to nine. In this sense, the electric signal that the microprocessor receives from the lever thus can be exactly equivalent to the electric signal received from a digital keypad in a calculator of the prior art.

In the embodiment of this example, the lever 10 can be tilted in eight directions that are denoted as follows: north, south, east, west, north-east, south-east, north-west and south-west. Furthermore, the direction of the longitudinal axis of the calculator is called north, with north being oriented towards the rear of the calculator. Each tilt direction of the lever is associated with the indication of a particular number. As shown in the figure, north corresponds to 8, south to 2, east to 5, west to 4, north-east to 9, south-east to 3, north-west to 7 and, finally, south-west to 1.

In addition to the eight active positions that have just been listed, the lever 10 of this example has two further positions that are respectively associated with the numbers 0 and 6. One of these two additional active positions is accessed simply by axially pressing the lever towards the upper face 28. FIG. 1 shows that this ninth active position corresponds to the number 0 in the example shown. A person skilled in the art has numerous possibilities at his disposal for defining the tenth and final active position (which in this example is associated with the number 6). From an ergonomics perspective, a satisfactory manner for entering the number “6” would be, for example, to simultaneously activate the lever 10 and one of the keys. For example, axially pressing the lever 10, as when entering a zero, and simultaneously pressing the “+” key with the index finger. The microprocessor then would be programmed to associate the number “6” with this combined action. However, it will be noted that this is not the solution used in the example shown. Indeed, it can be understood from FIG. 1 that the number “6” is entered by firstly tilting the lever 10 eastwards, as is the case for the number “5”. Subsequently, once the lever is in the eastern active position, an additional pressure is exerted in order to exceed a notch on the lever. The lever thus tilts eastwardly by an additional step, until it reaches an additional active position associated with the number “6”. The aforementioned solution, which is shown in FIG. 1, highlights the drawback of requiring the use of a non-standard lever granting access to a first and a second active position by tilting in the same direction. However, this solution has the significant advantage of allowing all the numbers from 0 to 9 to be entered using only the lever. In general, it can be said that the aforementioned solution is the most advantageous from an ergonomics perspective. It also will be noted that the correlation between the movements of the lever 10 and the corresponding numbers substantially reproduces the arrangement of the keys of a digital keypad.

In the embodiment shown, the lever 10 is also used to turn on the calculator. When the calculator is turned off and a user axially presses the lever towards the upper face 28, as when entering the number “0”, the action of the user turns on the calculator. Preferably, the calculator is designed to turn off automatically when nothing has been entered for a certain number of seconds.

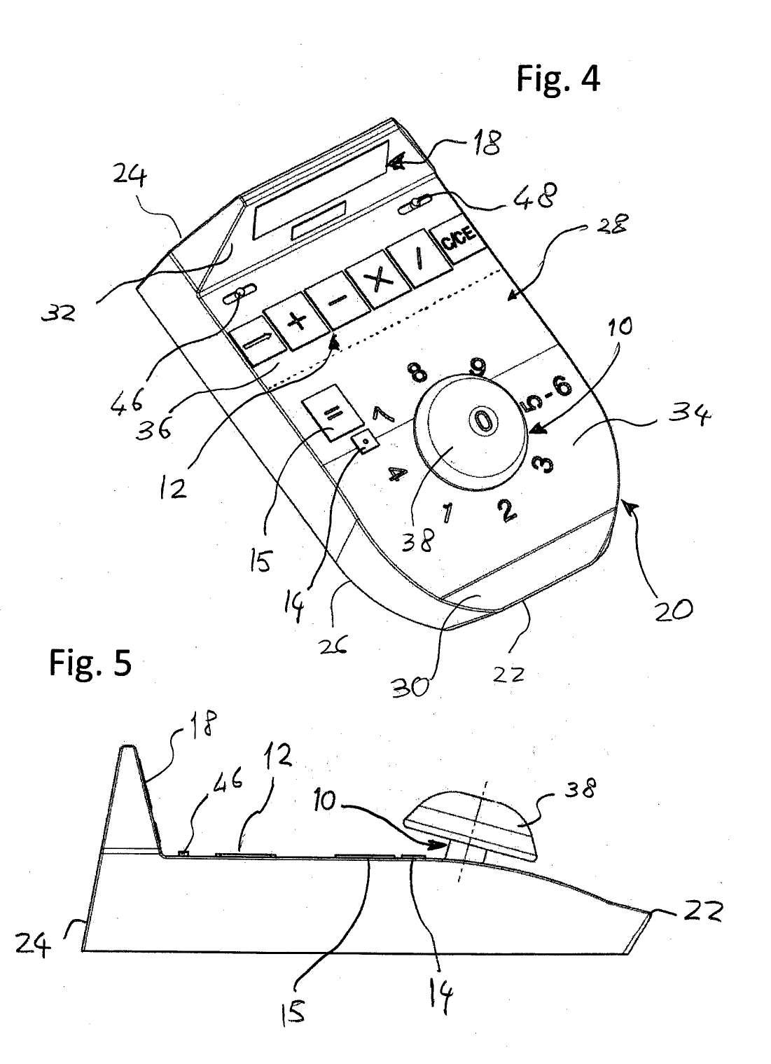

FIGS. 4 and 5 are respective perspective and side views of a calculator corresponding to a second embodiment of the invention. It is to be noted that the first and second embodiments of the invention have many common features. For this reason, the items in FIGS. 4 and 5 that are identical or are practically identical to the corresponding items of FIGS. 1, 2 and 3 are denoted using the same reference numerals.

Reference being made more specifically to FIG. 4, it can be seen that the calculator shown comprises two switches 46 and 48 that did not exist in the first embodiment. In the example shown, the switch 48 allows the number of decimals displayed for fractional numbers to be defined. The switch 46 is a three-way switch for selecting how the calculator rounds the fractional numbers. The first possibility is to always round down the numbers, the second possibility is to always round up the numbers and the third possibility is to round down numbers 1, 2, 3 and 4 and to round up numbers 5, 6, 7, 8 and 9.

FIG. 4 also shows that the calculator has six first keys that can be activated by the fingers of the hand. Among these keys, the four keys that occupy the most central positions respectively bear the signs that correspond to the four arithmetical operators. When a calculator user holds his right hand in the input position with his fingers tight together, his index finger faces the plus sign, his middle finger faces the minus sign, his ring finger faces the multiplication sign and, finally, his little finger faces the division sign. The first and the last position of the row of first keys are occupied by two keys that respectively bear an arrow→sign and the C/CE acronym. In a manner known per se, the →key allows the previously entered number to be deleted, whereas the C/CE key allows the ongoing calculation to be completely deleted in order to restart. When a calculator user holds his right hand in the input position, he can activate the →key with the index finger slightly separated from the other fingers. Similarly, he can activate the C/CE key with the little finger.

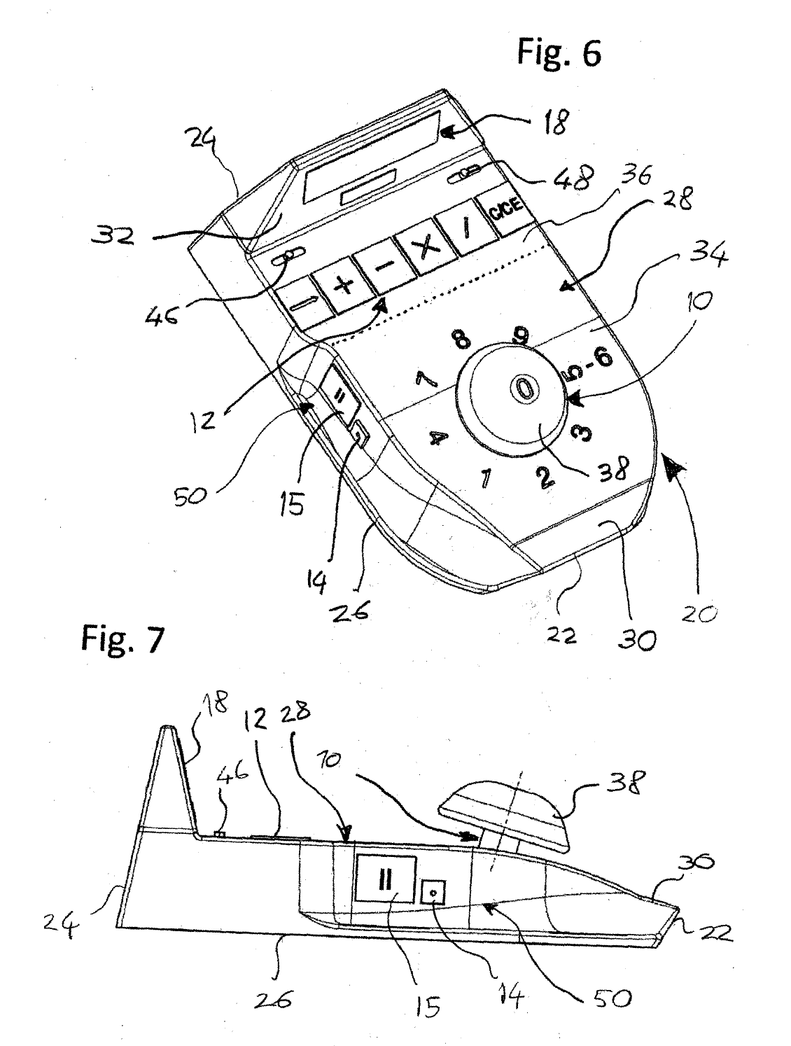

FIGS. 6 and 7 are respective perspective and side views of a calculator corresponding to a third embodiment of the invention. As can be seen from the figures, the third embodiment of the invention differs from the two preceding embodiments basically due to the fact that the second keys 14 and 15 are arranged on a lateral zone 50 of the casing 20, with the zone 50 being practically vertical. With more particular reference to FIG. 6, it can be understood that, as in the preceding embodiments, the second keys 14 and 15 are facing the thumb when the right hand of the user is in the input position. However, in the third embodiment, instead of being located above the second keys, the thumb is located next to said keys. Therefore, in order to activate the second keys, the thumb must perform an adduction movement instead of the antepulsion movement that was required with the two first embodiments of the calculator.

FIG. 8 is a perspective view of a calculator corresponding to a fourth embodiment. As will be seen, the fourth embodiment is particularly intended for left-handed users. By simultaneously referring to FIG. 6 and FIG. 8, it can be seen that the two calculators that are shown are very similar. The main difference resides in the fact that, in FIG. 8, the second keys 14 and 15 are located to the right of the lever 10 instead of being on the left. It will be understood that the calculator of FIG. 8 is designed to be activated using the left hand instead of the right hand. It also will be noted that, in the example shown, the sequence of the numbers around the lever is reversed compared to the three first embodiments. As shown in FIG. 8, north corresponds to 8, south to 2, east to 4, west to 5, north-east to 7, south-east to 1, north-west to 9 and, finally, south-west to 3. Finally, a final difference compared to the calculator of FIG. 6 is that the calculator of FIG. 8 only comprises four first keys, like the calculator of the first embodiment. However, in the fourth embodiment, the first keys are arranged in a different order.

It also will be understood that various modifications and/or clear improvements for a person skilled in the art can be made to the embodiments that are the object of this description, without departing from the scope of the present invention defined by the appended claims. In particular, with respect to the calculators that are designed to be activated with the left hand, it will be understood that they can have a lever 10 and first keys 12 identical to those of a calculator designed to be activated with the right hand. Only the position of the second keys necessarily has to be changed so that a calculator can be used with the other hand. Furthermore, a multitude of calculator models exists. Each calculator model has a set of keys specific thereto. The various sets of keys differ from each other both in terms of the number of keys and the functions of these keys. In particular, a multi-function calculator according to the invention optionally can comprise, in addition to first and second keys 12, 14 and 15, third keys arranged in an additional input zone. These third keys optionally even can be arranged to be activated by the second hand of the user. In these conditions, it will be particularly understood that the selection of the keys of the calculators described by way of example in the preceding description is provided solely by way of example, and that this selection thus can be changed in many ways without departing from the scope of the invention.

1-14. (canceled)

15. Electronic calculator comprising a power supply, an input interface (10, 12, 14, 15) for entering numbers and mathematical operations to be carried out, a memory for storing data, a microprocessor for carrying out operations on the entered numbers, a digital display device (18) for showing the result of operations carried out on the entered numbers and a casing (20) comprising a front edge (22) and a rear edge (24) located opposite each other, the casing further comprising a base (26) and an upper face (28) both extending between the rear edge (24) and the front edge (22), the input interface (10, 12, 14, 15) comprising a lever (10) projecting above the upper face (28) of the casing (20), the lever being designed to allow numbers to be entered manually and being arranged to be able to be selectively tilted in a plurality of active positions by being inclined in corresponding directions from a rest position, each direction corresponding to a different number, the microprocessor being arranged to associate every tilt of the lever in one of said active positions with the entry of the corresponding number, the upper face (28) comprising a front input zone (34) and a rear input zone (36), the lever (10) being located in the front input zone and the rear input zone having a plurality of first keys (12) respectively associated with mathematical operators, and the input interface (10, 12, 14, 15) further comprising at least one second key (14, 15),
wherein the first keys are positioned relative to the lever so that the ends of the fingers of a hand of a user each can be located facing one of the first keys (12) when the palm of said hand is turned downwards and the hollow of said hand covers the end of the lever (10), and
wherein said at least one second key (14, 15) is arranged on the casing (20) behind the lever (10) and is offset to the side relative to the longitudinal axis of the calculator so as to be facing the thumb of said hand when the fingers of said hand are facing the first keys (12), the hollow of said hand simultaneously covering the end of the lever (10).

16. Electronic calculator according to claim 15, wherein said at least one second key (14, 15) comprises an “equals” key (15).

17. Electronic calculator according to claim 15, wherein said at least one second key (14, 15) is arranged facing the thumb on the upper face (28) so that it can be activated by a downwards movement of the thumb.

18. Electronic calculator according to claim 15, wherein said at least one second key (14, 15) is arranged facing the thumb on a vertical or inclined surface of the casing (20), a normal line to said surface being oriented laterally so that said at least one second key can be activated by a movement of the thumb in the lateral direction.

19. Electronic calculator according to claim 15, wherein the rear input zone (36) is rearwardly inclined.

20. Electronic calculator according to claim 15, wherein the first keys (12) are arranged in the rear input zone (36) so as to form a straight row or a row in an arc of a circle.

21. Electronic calculator according to claim 20, wherein said row formed by the first keys (12) is oriented at a tangent to a circle concentric to the lever (10).

22. Electronic calculator according to claim 15, wherein the upper face (28) of the casing (20) comprises a support zone (30), the support zone being located between the front input zone (34) and the front edge (22) of the casing.

23. Electronic calculator according to claim 15, wherein the digital display device (18) is arranged in a window of the casing (20), the window being formed in a display zone (32) of the upper face (28), the display zone being located between the rear input zone (36) and the rear edge of the casing (24).

24. Electronic calculator according to claim 23, wherein the display zone (32) is vertical or inclined and wherein is facing forwards.

25. Electronic calculator according to claim 15, wherein the electronic calculator is adapted to be connected to a computer so as to act as an input interface for the computer.

26. Electronic calculator according to claim 25, wherein the electronic calculator is adapted to be connected to the computer by a wireless connection.

27. Electronic calculator according to claim 15, wherein said at least one second key (14, 15) is offset to the left-hand side relative to the longitudinal axis of the calculator so as to allow entry with the right hand only.

28. Electronic calculator according to claim 15, wherein said at least one second key (14, 15) is offset to the right-hand side relative to the longitudinal axis of the calculator so as to allow entry with the left hand only.

29. Electronic calculator according to claim 16, wherein said at least one second key (14, 15) is arranged facing the thumb on the upper face (28) so that it can be activated by a downwards movement of the thumb.

30. Electronic calculator according to claim 16, wherein said at least one second key (14, 15) is arranged facing the thumb on a vertical or inclined surface of the casing (20), a normal line to said surface being oriented laterally so that said at least one second key can be activated by a movement of the thumb in the lateral direction.

31. Electronic calculator according to claim 19, wherein the first keys (12) are arranged in the rear input zone (36) so as to form a straight row or a row in an arc of a circle.

32. Electronic calculator according to claim 16, wherein the upper face (28) of the casing (20) comprises a support zone (30), the support zone being located between the front input zone (34) and the front edge (22) of the casing.

33. Electronic calculator according to claim 17, wherein the upper face (28) of the casing (20) comprises a support zone (30), the support zone being located between the front input zone (34) and the front edge (22) of the casing.

34. Electronic calculator according to claim 18, wherein the upper face (28) of the casing (20) comprises a support zone (30), the support zone being located between the front input zone (34) and the front edge (22) of the casing.
